(19) United States
(12) Patent Application Publication
(10) Pub. No.: US 2026/0370547 A1
(43) Pub. Date: Nov. 19, 2026

(54) DAUGHTER SERVER

(71) Applicant: Intensivate Inc., San Francisco, CA (US)

(72) Inventor: Kevin Sean Halle, San Francisco, CA (US)

(73) Assignee: Intensivate Inc., San Francisco, CA (US)

(21) Appl. No.: 19/441,530

(22) Filed: Jan. 6, 2026

Related U.S. Application Data
(60) Provisional application No. 63/742,414, filed on Jan. 6, 2025.

(51) Int. Cl. H04L 41/0806

(52) U.S. Cl. CPC H04L 41/0806

(57) ABSTRACT

A method can include establishing, by a host server, communication with a daughter server. The communication can be established responsive to an electrical coupling of the daughter server with the host server. The daughter server can be disposed within a bay of the host server. The method can include engaging in a protocol, by the host server in combination with the daughter server. The protocol can be engaged responsive to establishing the communication between the host server and the daughter server. The protocol can move data between the host server and the daughter server. The data can be movable on an external network in the form of IP packets.

### CROSS-REFERENCE TO RELATED PATENT APPLICATION

This application claims the benefit of and priority to U.S. Provisional Patent Application No.: 63/742,414, filed Jan. 6, 2025, the entirety of which is incorporated by reference herein.

### BACKGROUND

Servers can receive requests and provide responses to the requests. Servers have a physical embodiment and a physical enclosure or housing, and some means to communicate with other computers.

### SUMMARY

This summary is provided to introduce a selection of concepts that are further described below in the detailed description. This summary is not intended to identify key features or essential features of the claimed subject matter, nor is it intended to be used to limit the scope of the claimed subject matter.

At least one embodiment relates to servers that are deployed in a convenient housing that reduces the barrier to adoption. The housing is in a standard SSD form factor or similar which allows the server to be conveniently deployed in existing Host servers without any change to the host server nor to the OS deployed in the Host server. Such daughter servers appear on the datacenter network as normal servers. Both Host server and daughter server may deploy normal, upstream, and unmodified Linux distributions or distributions of other operating systems.

Daughter servers that may be housed in SSD enclosures and may be plugged into a Host server may achieve the goal of having IP traffic automatically routed to those daughter servers by the existing operating system and networking software stack of the Host without requiring modifications to the operating system nor the kernel nor the networking software stack. A device driver may be added to the host as is required for any device that is plugged into a PCIe socket in a Host server. A configuration may be made in which the IP address of the daughter server is registered with the IP Table of the host server in order to enable packet forwarding to the daughter server by host server networking stack. The table may include ranges of IP addresses that map to drivers that have registered themselves to be of the network interface type, and the OS may use the table longest prefix match algorithm to match one of the interfaces to the destination IP address.

A daughter server may thus communicate with the host server over an electrical coupling that the daughter server may couple to as part of being disposed within a bay of the host server. The daughter server and host server may send and receive data over the electrical coupling via a device driver in the daughter server and a device driver in the host server that may have registered themselves to be of the network interface type. The host server may receive, from a computing device via an external network, one or more packets via a physical network interface device coupled to the external network that may be in or part of the host server. Data associated with or included in the one or more packets may be transmitted over the electrical coupling between daughter server memory and host server memory.

Host servers and daughter servers engage in a protocol that moves data between host and daughter server such that the data is movable on the external network as IP packets.

The daughter server thus has a normal, upstream, and unmodified Linux distribution, as does the Host. The daughter server sends and receives packets in the same way as if the daughter server was directly connected to the external network, without modification of the operating system of daughter server OS nor modification of the Host server OS to enable the sending and receiving of the packets despite the daughter server being physically plugged into a socket in the Host server and so not itself being directly connected to a network.

At least one embodiment relates to a method. The method can include establishing, by a host server, communication with a daughter server. The communication can be established responsive to an electrical coupling of the daughter server with the host server. The daughter server can be disposed within a bay of the host server. The method can include engaging in a protocol by the host server in combination with the daughter server. The protocol can be engaged responsive to establishing the communication between the host server and the daughter server. The protocol can move data between the host server and the daughter server. The data can be movable on an external network in the form of IP packets.

At least one embodiment relates to a system. The system can include a host server. The host server can include one or more bays. A device can be disposed within a bay of the one or more bays. The device can include an IP address. The device can be electrically coupled to the host server via the bay. The IP address of the device can be reachable from an external network.

At least one embodiment relates to a system. The system can include a host server. The host server can include one or more bays. Each bay of the one or more abys can receive a device that is packaged in a predefined housing. The system can include a daughter server. The daughter server can be at least partially disposed in a bay of the one or more bays. An electrical coupling can be established between the host server and the daughter server. First data can be exchanged, via the electrical coupling from memory of the host server to memory of the daughter server. Second data can be exchanged, via the electrical coupling, from the memory of the daughter server to the memory of the host server. The daughter server can be discoverable on an external network. The daughter server can provide one or more services to a remote device that is on the external network.

### BRIEF DESCRIPTION OF THE DRAWINGS

FIG. 1 is a perspective view of a server including bays that can each be used to receive a Solid State Drive, and SSD are partially inserted into the server, according to the typical use of such servers. In addition, the bay can be used to receive a daughter server that is configured to have the same housing as a solid state drive. FIG. 1 additionally shows daughter servers that are at least partially inserted into the server, according to some embodiments.

FIG. 2 is a block diagram of a system that includes the Host server and the daughter servers of FIG. 1, according to some embodiments.

FIG. 3 is a block diagram that includes a subset of FIG. 2 with additional detail.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### OVERVIEW

A physical server having a form factor in accordance with a solid state drive (SSD) form factor is described herein. The physical server can be placed and/or positioned within a bay of a second physical server where such a bay may typically be intended, configured, or designed to receive an SSD. Accordingly, as described herein, a server positioned within a bay of a host server is referred to as a daughter server. More generally, we refer to any server as a daughter server when the server is placed inside the enclosure or enclosure extension such as a JBOD enclosure of another server, and we refer to a server that receives a daughter server as a host server. Stated otherwise, the daughter server is located in a bay of the host server. For example, the daughter server can be plugged into an SSD bay and is thereby electrically coupled to the host server. Information packets can then be sent through the electrical coupling as a means to communicate between daughter server and host server.

Physical servers are computing devices that can be connected, over a network, to other computers and computing devices. The physical servers can execute and/or run services that are used by the other computers. The other computers that use the services of a physical server are often referred to as clients, mobile devices, and/or edge devices. Physical servers are distinguished from software servers in that physical servers include hardware, such as a rack mounted server. Conversely, software servers are code that is run on a compute device. Software servers can include open source software packages, such as Apache Tomcat, nginx, and so on.

Daughter server enclosures may be one of EDSFF E1.s, E1.L, EDSFF E3.s, E3.L, U.2, M.4 or any enclosure defined by Storage Networking Industry Associate (SNIA) or SSD Form Factor Working Group or similar, or any enclosure that fits within a bay in a host server that conforms to any enclosure defined by one of those standards bodies or the Open Compute Project or similar standards bodies, and includes specifications of bays and electrical connections that are published or implemented by individual server manufacturers or server enclosure manufacturers. an enterprise datacenter standard form factor (EDSFF).

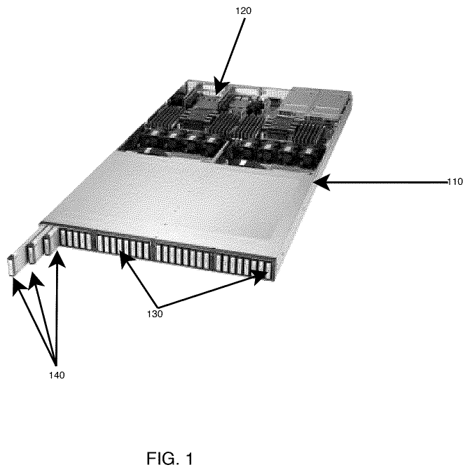

Although FIG. 1 shows a Host that has the EDSFF type of SSD plugged in, this is for illustrative purposes only and as such any type of plug in device for which the Host OS is capable of loading a device driver for that plugin where the device driver can be written in such a way that it registers itself of the network interface type.

The software servers can be executed in accordance with an underlying operating system. For example, the software servers can be run under a Linux Operating System (OS) as a daemon. The physical servers can be configured to execute (e.g., start.) the open source software packages (e.g., the software servers). The software servers can listen to and/or monitor ports (e.g., Internet Protocol (IP) ports, connection endpoints, etc.) to receive incoming messages (e.g., requests, data packets, etc.) that have been routed to the physical server.

Data centers are locations that house and/or include multiple physical servers (e.g., a collection of multiple physical servers). For example, data centers can include buildings or rooms that are dedicated to housing servers. The servers can be housed in an enclosure that has a physical form factor (e.g., size, dimension, arrangement, etc.). For example, the type “rack mount” can be a form factor of server enclosures. Enclosures of the type rack mount can have dimensions and functionality that conform to those stated in a specification that is published by an official standards body such as the Open Compute Project standards body. As another example, a server enclosure form factor can include a tower enclosure.

The total power available to a data center building is a key constraint due to the large number of physical servers housed inside the data center building. Data centers are normally designed to consume the maximum amount of electrical power that is readily available from the surrounding infrastructure (utility wiring to the building). Accordingly, the total amount of computation work per hour that can be performed inside a given data center building is limited by the energy per work consumed by the servers that are performing the work. Consider two physical servers. Both perform work per time at the same rate. One consumes more power than the other, even though both deliver the same work per time. If a first data center building is populated with the type of server that consumes more power, and a second data center building is populated with the type of server that consumes less power, and both data center buildings have the same maximum utility power to the building, then the sum of all work per time produced by the servers in the first data center building will be less than the sum of all work per time produced by the servers in the second data center building. The main determiner of how much work per time is produced from a given amount of energy per time, in a given semiconductor process node is the micro-architecture of the processor core. In the context of a physical server, a CPU is a package that houses processor cores. Data centers routinely populate their buildings with servers that contain CPUs that internally implement the out of order style of micro-architecture that employs structures that analyze the dependencies among the instructions of a single thread of execution.

Out of order micro-architectures are implemented to find independent instructions that can be run at the same time, in a different order than stated by the program, but still give correct final results. Performing out of order execution of instructions increases the speed at which a single thread of execution can be performed. However, the logic that implements out of order execution is overhead as the logic does not contribute to the work itself (e.g., the execution of instructions) but rather only increases the rate of the work. As a result, the use of servers that contain CPUs whose cores are implemented according to out of order micro-architectures increases the consumption of electrical power per work per time of the server and therefore reduces the total amount of work per time that can be performed within the fixed power available to the data center building. In some implementations of out of order micro architectures, the overhead described in this paragraph can account for 90% of all electrical energy consumed per instruction. Stated otherwise, 90% of electrical energy consumed per instruction is wasted on overhead. The CPU of a server consumes the majority of the power of a server, and server power is the largest consumer of power in a typical data center.

Adoption of a new kind of CPU into a data center carries risk to the customer. Data centers are complex, and any new element causes unforeseeable consequences. As a result, customers perceive a risk to adopting a new computing device into their data center. In addition, any new computing device requires significant effort. The customer must create new processes and procedures for that new type of computing device, and the customer must spend significant time testing the new device and how it interacts with the rest of the data center. As a result, the barrier to adopting a new kind of CPU is lower when there is minimal disruption when adopting a computing device that contains that CPU. Housing such a new kind of CPU within the housing of an SSD, allows the computing device to be inserted into a bay of an already approved host computing device, which thereby reduces the perceived risk and reduces the effort to adopt such a new computing device.

When new hardware technology requires a change in software in order to make use of the new hardware, then the risk to company schedule and cost of modifying software is often judged by the customer to be a greater negative than the positive benefit of the new hardware. As a result, new CPU technology must require minimal software changes in order to achieve a high rate of adoption.

### Differentiation

The present disclosure describes a daughter server that may not require any changes to software of the daughter server and may not require a change to software of the host server. In particular, there may not be a need to change the OS of either daughter server or host server nor the need to start special processes whose purpose is to facilitate communication between host server and daughter server. A daughter server as disclosed herein may be able to use off-the-shelf industry standard OS mechanisms, and may be able to run applications un-modified. As a result, products implemented according to the teachings of the present disclosure may not experience a software related barrier to adoption.

In contrast, computational storage via NVMe originally used a feature of NVMe to perform so-called “piggyback” where custom format data is carried as payload in an NVMe command. Since then, the SNIA standards body has expanded the NVMe protocol to support computational storage.

For Computational Storage via NVMe, the device driver in the Host is an NVMe type of device driver. That means that the Host OS sees an NVMe interface. Thus the Computational Storage via NVMe device that is plugged into the Host physical server is seen by the Host OS as a storage device that uses the NVMe interface. This means that the standard networking software infrastructure does not function together with computational storage devices that use the NVMe protocol to interact with the Host physical server. The present disclosure discusses a method by which an NVMe style of computational storage device may be enhanced to become able to appear on the datacenter network with its own IP address and becomes discoverable by ARP and provide services to other devices by means of IP packets sent back and forth.

As a result of the Host OS seeing the device that is plugged in as an NVMe storage device, special software must be written and installed, or a customized version of the OS kernel must be written and used in order for TCP packets to be moved between the plugged in device and the datacenter network (or internet). Computational Storage devices that use NVMe protocol are typically used as offload engines and not as servers that are discoverable on the datacenter network, due to the circumstance that the low performance does not provide significant value in using such devices as general servers.

In some embodiments, communication of packet data between the host server and the daughter server occurs without tunneling. As used herein, “tunneling” refers to encapsulating packet data, packet headers, packet meta-data, or higher-layer networking information inside a payload field of an unrelated protocol message or command that is nominally of a different protocol type than the communicated packet data. For example, tunneling includes carrying packet data or packet meta-data within a storage-protocol command payload, within a vendor-specific field of a storage-protocol command, or within an extended command format used for storage operations, where the packet data is “piggybacked” inside the storage-protocol command as transported content.

In some embodiments of the present disclosure, the host server and the daughter server communicate packet data without tunneling by transferring the packet data itself, and optionally associated meta-data, directly between host memory and daughter memory via direct memory access (DMA) over the PCIe wires between daughter server and Host server. In such embodiments, a device driver in Host and a device driver in daughter server memory engage in a protocol that coordinates memory addresses, lengths, and completion notifications, and the packet data is conveyed as packet data rather than as payload embedded within an unrelated command type. For example, the packet data may be stored as a packet in Host memory and transferred as a packet in daughter server memory, or vice versa, by DMA transactions initiated by the host server and/or the daughter server over the PCIe wires between daughter server and Host server.

In some embodiments, “without tunneling” further includes that the transfer of packet data and associated meta-data between the host server and the daughter server does not require formatting the packet data as a storage request, does not require placing the packet data into a vendor-specific payload of a storage command, and does not require causing the host OS/kernel in host memory to treat the daughter server as a storage endpoint for purposes of transporting the packet data. Instead, in some embodiments, the device driver in Host and the device driver in daughter server memory present and consume the packet data through network-interface abstractions associated with the host OS/kernel in host memory and the daughter OS, and the packet data is conveyed between host memory and daughter memory by DMA over the PCIe wires between daughter server and Host server under control of the respective device drivers.

In some embodiments, the absence of tunneling enables the operating system networking stack on the host, and operating system networking stack on the daughter, to operate using packet-based data structures and routing/forwarding logic, including selecting the daughter-server interface using longest-prefix-match routing rules in a forwarding table in Host, while the underlying transfer of packet content between host memory and daughter memory is performed as direct memory movement over the PCIe wires between daughter server and Host server, rather than as a transport payload embedded inside a distinct protocol command.

Note that the disclosure describes something different from technologies such as IPoPCIe. Technologies such as IPoPCIe are a method for two Host physical servers to send IP packets to each other by using a PCIe electrical switching network instead of an Ethernet electrical switching network. Such technology is not capable of allowing communication between a Host server and a PCIe endpoint device that is plugged into the Host server's physical PCIe slot.

Note PCI Non-Transparent Bridges (NTB) allows two host systems to communicate with each other by exposing each host as a device to the other host. NTBs typically support the ability to generate interrupts on the remote machine, expose memory ranges as BARs, and perform DMA. PCI NTB Function allows two different systems (or hosts) to communicate with each other by configuring the endpoint instances in such a way that transactions from one system are routed to the other system. In one example a PCI NTB function configures an SoC that has multiple PCI Endpoint (EP) instances. The SoC plus PCI NTB allow transactions from one EP controller to be routed to the other EP controller. Once the PCI NTB function configures the SoC with multiple EP instances, HOST1 and HOST2 can communicate with each other using SoC as a bridge.

The present disclosure differs from NTB. For NTB, both servers are host servers that are in separate stand alone enclosures. Neither is inserted into a bay of the other.

The techniques described herein may overcome the aforementioned technical deficiencies. A SuperThread type of CPU has a much higher rate of work per hour for a given amount of energy per hour when compared with a typical out of order type of CPU. An example of a SuperThread type CPU is discussed in U.S. patent application Ser. No. 18/649,817, filed Apr. 29, 2024, the entirety of which is incorporated by reference herein. If a SuperThread type of CPU is employed in a server, then the total power of the server may be within the maximum power that a typical SSD may consume. In this case such a server may be implemented within a housing that is in the form of an SSD such that the physical server can be inserted, as a daughter server, into a bay of a host server. The ability to insert such a daughter server into an existing host server has several benefits because it reduces the risk to the customer of adopting a new computing device into their data center, as well as reducing the effort required to qualify the computing device for use in their data center, thus the barrier to adoption of such higher efficiency CPU technology is lowered by placing such CPUs inside an SSD housing. Any CPU that uses a similar strategy to gain high performance by leveraging multiple HW threads instead of logic that finds high concurrency in a single thread may be effective when used as the CPU in a daughter server. Such a CPU can be referred to as a Daughter Appropriate CPU or a Cluster Compute style CPU. Such a CPU may have lower single threaded performance but higher total throughput across all hardware threads combined, at lower energy per instruction completed when compared to an out of order style CPU that has been designed for maximum single threaded performance.

Note that Servers that have performance that is comparable to typical servers that are commonly employed in data centers can be termed Enterprise level servers. Customers may value a server (e.g., a daughter server) housed in an SSD or similar housing in the server, alone or many together in the same host, has performance that compares favorably to typical servers that are available at the time. Such a daughter server can be considered an Enterprise level server due to its level of performance

To avoid a software risk to adoption of daughter server style servers, the daughter server can be integrated with the host server in such a way that the integration can be accomplished with little or no modification or adjustments to the host server software. When any device is plugged into a host server, the operating system of the host server starts a device driver for that device. Each device driver must specify the device driver's type when it registers with the OS. When the Host OS detects the daughter server that is plugged into a PCIe socket, the Host OS looks up the device driver for the daughter server hardware and starts that device driver in the Host OS. The device driver must tell the OS what type it is (storage, network interface, etc.). The device driver for the daughter server tells the Host OS that it is of the network interface type which connects the driver to the networking functionality that is part of the OS (or an alternative networking stack installed on the Host server), which in turn enables the OS's network stack (or alternative networking stack) to perform forwarding of packets to and from the device driver. Advantageously, the daughter server is thereby reachable via the ARP protocol, as well as able to send and receive IP packets, to and from the datacenter network even though the daughter server is not directly connected to the datacenter network and does not have the type of network hardware that is normally required for a server to be reachable from a datacenter network.

Note that the device driver to a daughter server may alternatively register itself or otherwise interact with alternatives to the built-in networking stack that is part of common operating systems such as Linux, Unix, and Windows. Some alternatives include VPP, demikernel, and similar. A demikernel is a library OS architecture for kernel-bypass I/O in data center servers that uses library OSes to flexibly provide an abstraction across different kernel-bypass devices. When using an alternative, the process for registering a device driver and the terms used for the type of interface may be different from the terms “Network Interface type of device driver” and similar terms. Fitting with the form of networking infrastructure that the host server uses or daughter server uses is what matters, the exact details of the interface between the software that handles packets and device driver is not material, Things such as packet forwarding may take place completely inside alternative software stacks and not interact with the OS. The device drivers may still be involved.

The daughter server itself also has an operating system. The operating system of the daughter server also loads a daughter to host (DTH) device driver that registers itself to be of the type network interface (e.g., a network device driver), and this happens within the OS of the daughter server. The DTH device driver of the daughter server can interact with PCIe End Point logic that is part of the daughter server. Once a host to daughter (HTD) device driver is registered with the operating system of the host server and the DTH device driver is registered with the operating system of the daughter server, the daughter server and the host server can communicate with one another, without any software modifications. For example, the two computing devices may communicate without any modifications to the OS of the host server or the OS of the daughter server. As another example, the two computing devices may communicate without any modifications to the kernel or without loading software onto either the daughter server or the host server in order to implement communication between the two. A peripheral component interconnect Express (PCIe) bus that electrically connects the daughter server to the host server is thereby enabled to carry IP packets between daughter server and host server. For example, packet exchange may take place by PCIe logic that automates DMA style of transfer of the data of IP packets between Host server and daughter server.

Note that either the host server or the daughter server may initiate the DMA transfer. In all cases, the data is transferred between the memory of the host server and the memory of the daughter server. Such DMA may take place over electrical connections that are of types other than PCIe, e.g., fibre channel, ethernet, and so on. The particular protocol between DTH device driver and HTD device driver may have any combination of: HTD device driver initiates all DMAs, DTH device driver initiates all DMAs, HTD device driver initiates some DMAs and DTH device driver initiates some DMAs.

Note that while the operation may be described in terms of the PCIe type of electrical connection and protocol, other types of electrical connection may also be implemented and/or utilized. Examples include SATA, SAS, SCSI, iSCSI, even IDE, for which a device driver may be written that registers itself as a network interface, but internally uses the protocol. In these cases, the electrical connection and base protocol on the socket, into which the daughter server is plugged, is intended for a storage device. In this case the HTD device driver internally implements the storage protocol and “writes” and “reads” blocks on the storage device as the means to transfer data between host server and daughter server. The DTH device driver internally may set flags and set certain meta data by using MMIO techniques. Such values in registers may then be mapped by logic in the daughter server into data that appears within certain blocks, where a block is the normal unit of address and transfer for a storage device. The DTH device driver, and the HTD device driver may each still register itself to be of the network interface type, but internally it uses the protocol supported by the socket of the host to which the daughter server is connected. The data may be in raw form and is packetized once it is on the Host (or helper device) and vice versa, packets destined for the daughter are unpacketized and the payload data collected into chunks and the chunks are transferred, or individual packets may be transferred. The key element is for a daughter server (that is encapsulated inside the housing of a device that plugs into a bay of the host) to have the ability to be the initiator of a transfer of data to the host so that the data may be sent out over a network by the host or helper devices such as a smart NIC or Data Processing Unit.

The transfer may be in the form of large chunks of data to be transferred (accompanied by appropriate meta data such as size, destination address, and so on). The transfer may also be in the form of individual packets that already have headers wrapped around the data, or any other form that is convenient. The essential need is for the ability to make the host server aware that data is waiting to be transferred out of the daughter server. This essential need may be met by means of an interrupt that is initiated by the daughter server and interrupts the host CPU or other computing element on the host server such as a DPU or some other device that handles communication.

Some protocols such as SATA supply a mechanism by which the device may trigger an interrupt of the host. For example in the case of SATA, the TCQ mechanism may be used to accomplish interrupting the host. The host interrupt service routine may then initiate a read from the SATA device at a predetermined location. The read may be a normal storage style operation. The DTH device driver on the daughter server may provide meta data about the transfer at that predetermined location. The host server may then perform additional reads based on the meta data obtained on the first read and thereby accomplish the data transfer desired by the daughter server.

Some protocols may not include a mechanism by which a device electrically connected to a socket is able to initiate an interrupt of the host. In such cases the DTH device driver on the daughter server may raise a flag at a predetermined location to signal that the device wishes to transfer data. The HTD device driver in the host periodically reads the flag and when the DTH device driver sees that the flag is set, the driver initiates a read operation, in the same fashion as a read from a storage device, or leveraging the electronic capabilities of the connection to perform the equivalent of a DMA transfer of data from daughter server to host.

### Figure Introduction

FIG. 1 shows a perspective view of a server (shown as host server 110) including a plurality of bays (shown as bays 130) that are designed to receive a plug in device which may typically be a solid state drive, a spinning disk drive, or similar. In some embodiments, the bay dimensions and functionality are according to an industry defined standard such as Open Compute Project. Such a server is referred to as the host server 110. A plurality of servers (shown as daughter servers 140) are each housed in an enclosure that is compatible with the dimensions of the bays 130 that are in host server 110.

A Daughter Server may refer to or include a physical server whose form factor allows it to be inserted into a bay in a Host Server, has a server quality OS, has its own IP address, can be a source of packets to other devices or can be a destination of packets from other devices. External devices may be able to send packets to the daughter server, wherein the host server's only role may be passing the data through to and from the daughter server. A daughter server may include a means by which to connect to a socket within a bay, wherein an electrical connection is established between daughter server and host server.

Note that blade servers are physical servers whose form factor is such that they plug into a special blade enclosure, however a blade enclosure is not a server in its own right due to the fact that a blade enclosure, in standard practice, is not used to boot an operating system nor is a blade enclosure used to run applications in standard practice. Therefore, the blade servers that are plugged into a blade enclosure, where the blade enclosure does not itself boot an operating system, such as Linux, nor run applications, are not considered to be daughter servers as defined herein.

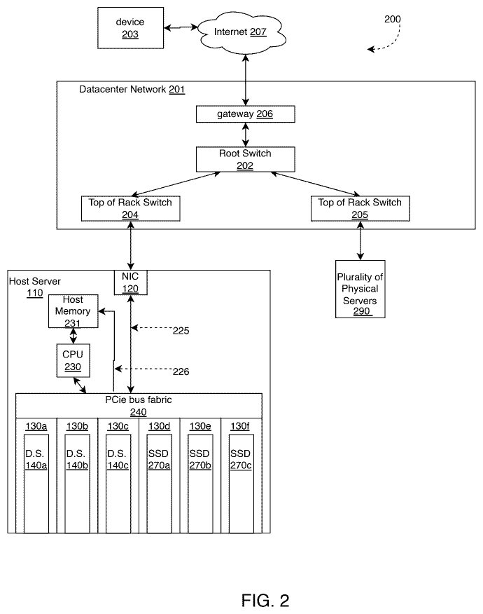

FIG. 2 shows a schematic view of a datacenter network 201, and includes a schematic view of the inside of the host server 110 which includes a Network Interface Card or network interface device (shown as NIC 120 in FIG. 1) that in turn connects to an external network (e.g., the datacenter network 201), a host CPU (shown as CPU 230), host memory 231, a PCIe bus fabric 240, and a plurality of bays (shown as bays 130a-130f) that are identical and may receive SSDs, or alternatively Daughter servers may be disposed within one or more of the bays 130a-130f. In some bays are inserted (or disposed) one or more servers (shown as daughter servers 140a-140c) and in other bays are inserted SSDs (shown as SSDs 270a-270c). FIG. 2 also shows a datacenter network 201 (which is external to the host server 110) that carries packets among servers and other devices within the data center. A datacenter network normally consists of a collection of switches. There are so-called Top of Rack switches (AKA TOR switch) and Root Switches. The top of rack switch 204 and the top of rack switch 205 connect directly to servers, while root switches connect to top of rack switches below and higher level root switches above, normally a path to a wider network such as the internet is provided.

Note that a network interface card is one form of a network interface device. A network interface device may interact with a CPU or peripheral management logic on one side and a physical electrical medium on the other side wherein that medium carries the information bits of the packet. Such a medium may include transmission over copper, transmission over fiber, light transmission, Wi-Fi, radio band signal; microwave band signal or similar. The protocol that is layered on top of the electrical connection can be ethernet or fibrechannel; or InfiniBand, RoCE, or similar.

The CPU 230 represents the main CPU in the host server 110. The CPU 230 runs an Operating System (shown as host OS 341), a network stack (which normally is part of the operating system but can also be a separate application such as Vector Packet Processor AKA VPP), a device driver for the NIC (shown as NIC device driver 344), and a device driver for each item that is connected to the PCIe bus fabric 240. Each of the plurality of Daughter Servers 140a to 140c and each of the plurality of SSD 270a to 270c is associated with a device driver that is started, as part of the standard PCIe mechanism, in the host OS 341 by which the host OS 341 interacts with the hardware that is connected to the PCIe bus fabric 240 by means of device driver. The device drivers that are started in Host OS for the Daughter Servers register themselves to be of the type “Network Interface.” By choosing to register of the type Network Interface, these device drivers are automatically connected to the networking stack that runs in the Host Server. In some embodiments, at least one system, device, and/or component, illustrated in FIG. 2, is communicably coupled with at least one second system, device, and/or component such that information and/or data may be exchanged and/or transmitted between one another.

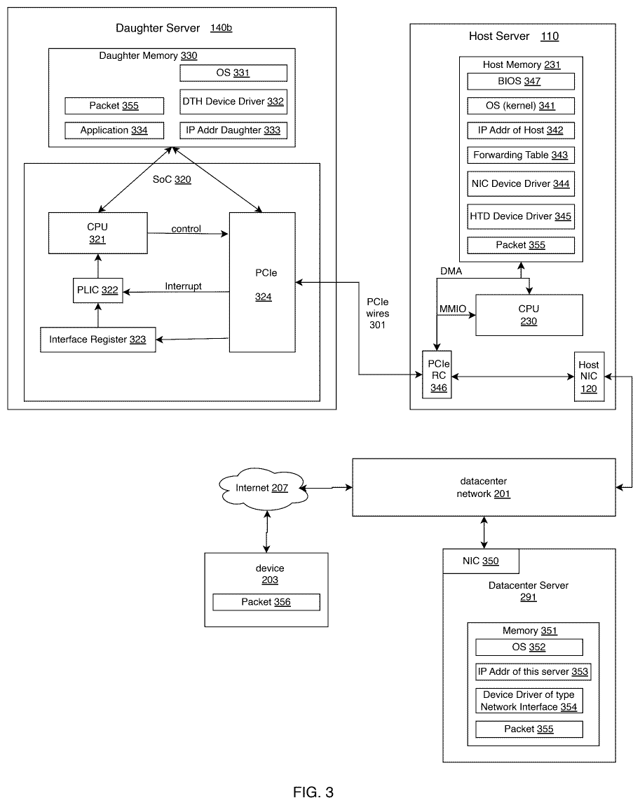

FIG. 3 depicts a block diagram of a system 300 for which one or more data packets may be exchanged, according to some embodiments. As shown in FIG. 3, the system 300 includes daughter servers 140, host server 110, datacenter network 201, datacenter server 291, internet 207, and device 203. In some embodiments, the system 300 may refer to or include at least one of the various systems, devices, elements, or components described herein.

### Setup

In some embodiments, host memory 231 may contain at least one operating system (e.g., the host OS 341), an Internet Protocol (IP) address 342 (e.g., IP address of the host server 110), a forwarding table 343, a device driver (shown as NIC device driver 344) of type network interface that communicates with the NIC 120, a device driver (shown as HTD device driver 345) of type network interface that communicates with the daughter server 140b, and one or more packets 355. The packets 355 may refer to or include one or more packets forwarded to the host server 110 from the datacenter network 201 or from one of the daughter servers 140. The packets 355 may also include one or more packets sent from one of the daughter servers 140 or one or more packets that were originated by an application in the host server 110.

In some embodiments, the present disclosure includes a two-way “network interface controller (NIC) interface” between a host server 110 and a daughter server 140b. In such embodiments, the host server and the daughter server both are configured with a device driver that is registered as being of the “network interface” type, and each side can therefore see the other side as a NIC-style interface.

In some embodiments, the host server operating system (shown as the host OS 341) includes the HTD device driver 345 that registers as a network interface, for example in the same manner that a NIC card driver registers as a network interface. In parallel, the daughter server operating system (shown as daughter OS 331) includes a device driver that likewise registers itself as a network interface, such that, from the perspective of each OS, the other side appears as a conventional NIC-type network device.

In certain embodiments, the daughter server device driver (shown as DTH device driver 332) is configured to communicate with PCIe endpoint logic 324 on the same integrated circuit as the daughter server CPU using memory-mapped I/O (MMIO). The endpoint driver can program registers associated with a PCIe endpoint intellectual-property (IP) block (e.g., PCIe endpoint logic 324) that implements the physical and protocol-level interface to the host server. In these embodiments, information and/or packets may be transferred over the PCIe electrical connection using direct memory access (DMA) and related mechanisms as described elsewhere in this description.

In some embodiments, one or more MAC addresses are used to direct packets between the datacenter network 201 and the host server 110, and between the host server and the daughter server 140b. For example, a MAC address of the host NIC can be used to cause an incoming packet to reach the NIC 120. The packet may be received by the host NIC hardware and delivered to the NIC device driver 344, which provides the packet to the host OS 341. The host OS 341 may use IP-layer processing and a forwarding table 343 to determine that the destination IP address of the packet is associated with the daughter server 140b, and may forward the packet to a host-to-daughter (e.g., the HTD device driver 345) that is of type network interface. The HTD device driver 345 may communicate with a corresponding device driver (e.g., the DTH device driver 332) in the daughter server 140b, and may cause the packet to be copied, for example by DMA, from host memory 231 into daughter memory 330. The packet may then be provided by the DTH device driver to the daughter server network stack within the daughter OS 331 and, ultimately, to an application running on the daughter server 140b. Thus the host server may pass packets to the daughter server via a host to daughter (HTD) device driver, which may include the host server storing packet payload data, meta data and/or full packets in host memory, then transmitting a message to the daughter server with information about the size and location of the payload data or meta data or full packets, and the daughter server may retrieve the data, packets, and/or payload data, and may do so via DMA over the PCIe wires 301.

In some embodiments, the disclosed system leverages built-in packet forwarding functionality that is already present in existing operating-system network stacks or in alternative networking stacks (e.g., user-space stacks). In such embodiments, the host OS 341 or other networking stack is configured with a forwarding table 343 that includes entries for both (i) the NIC-facing network interface (e.g., the NIC device driver 344) corresponding to the external network and (ii) one or more daughter server-facing network interfaces (e.g., the HTD device driver 345) corresponding to the daughter servers. When a packet is received on one interface, the forwarding logic evaluates the destination IP address and forwards the packet to the appropriate network interface in accordance with that table.

In various embodiments, the HTD device driver 345 and/or the DTH device driver 332 can be provided as part of an upstream, unmodified operating-system kernel. For example, a Linux kernel may include such a driver as an in-tree driver that can be built into the kernel image. In other embodiments, the driver may be provided as a loadable kernel module that can be installed on the host server after deployment. Still other embodiments allow the driver functionality to be provided, in whole or in part, in user-space software that cooperates with OS or user-space networking stacks and acts as a trampoline between a storage-attached server (SAS) interface and the network-stack interfaces.

In some embodiments, the daughter server 140b is coupled to the host server 110 via a PCIe bus consisting of partially of wires (shown as PCIe wires 301) and a device driver (e.g., the DTH device driver 332) executing on the daughter server may be configured to perform direct memory access (DMA) transfers directly over the PCIe bus between memory of the daughter server (e.g., daughter DRAM) and memory of the host server (e.g., host memory 231). Likewise, in such embodiments, the HTD device driver 345 executing on the host server 110 may be configured to perform DMA transfers directly between host memory and daughter memory over the same PCIe bus.

In some embodiments, the DTH device driver 332 may communicate with the PCIe endpoint logic 324 via memory mapped IO or some other mechanism by which CPU cores communicate with other logic, for example MMIO that uses a network on chip to talk to a PCIe End Point logic that is integrated into the same System on Chip (AKA SoC).

Note that each daughter server is normally configured with a unique IP address. This enables any computer attached to the network to use the ARP protocol to discover the presence of any of the daughter servers that are in the host, by giving ARP the IP address of the target daughter server and thereby establishing a route between the requesting computer and the daughter server that has that IP address. In this way, all the daughter servers that are inside the Host appear on the datacenter network and are reachable via the daughter server's IP address, the same as the Host itself or any other server that is on the datacenter network.

### Enterprise Level Server

In some embodiments, the daughter server 140b is implemented as an enterprise-level server housed inside an enclosure having a solid-state-drive (SSD) form factor. As used here, the term “enterprise-level server” refers to a server whose CPU performance, memory capacity, and network capability are comparable to those of datacenter servers, and is distinguished from devices that have relatively weak CPUs, such as certain SSDs with embedded controllers, SmartNICs, routers, and so on. A mechanism in the host can be used that serves the same role as the HTD device driver 345 but uses a different transport mechanism, such as a process started in the host and a TAP interface or similar network feature that acts as a relay between the device and the network. An example might be using the “piggyback” feature of the NVMe protocol, in combination with such a process plus interface in the host to make devices reachable from the datacenter network via an IP address.

In some embodiments, the daughter server leverages a “SuperThread” style CPU or other cluster-compute targeted CPU that is optimized to provide high server-class performance within the power and thermal footprint of an SSD form factor. For example, the daughter server CPU may be configured with many hardware threads, high memory bandwidth, and/or specialized accelerators to support enterprise workloads while staying within the power envelope typically associated with SSDs.

### Transparent Operation

In some embodiments, the host server 110 perceives the transfer of packets 355 between the NIC 120 and the daughter server 140b as a forwarding operation between two network interfaces. That is, from the perspective of the host OS/kernel (e.g., the host OS 341), the same network-stack forwarding behavior that applies when forwarding between two ordinary NICs is reused for forwarding between the NIC 120 and the daughter server interface associated with the HTD device driver 345. At the same time, the daughter OS 331 perceives packet reception as if the packet 355 had been received from an external network. In this way, the daughter server 140b can run a normal, upstream, and unmodified Linux distribution (or other OS distribution), and can send and receive packets in the same way as if the daughter server 140b were directly connected to the external network.

For example, in some embodiments a daughter server 140b may host a website or other network service that is accessible from the Internet 207. External clients, such as a device on the Internet 207, can send IP packets 356 to an IP address 333 of the daughter server 140b. Those packets are routed through the Internet 207 and the datacenter network 201 to the NIC 120, forwarded by the host OS/kernel (e.g., the host OS 341) from the NIC 120 to the daughter server interface based on the forwarding table 343 in Host, transferred into daughter memory 330 over the PCIe connection (e.g., the PCIe wires 301), and finally delivered to the daughter server TCP/IP stack in the daughter OS 331 and to an application in daughter memory 330 in the same manner as if the daughter server 140b were directly cabled to the datacenter network 201. No modification of the daughter OS 331 is required to enable this behavior.

In some embodiments, the host-side and daughter-side functionality disclosed herein is implemented primarily in device drivers, including a host to driver device driver (e.g., the HTD device driver 345) and a daughter to host device driver (e.g., the DTH device driver 332), that integrate with the operating-system kernel and networking subsystem. In such embodiments, the host OS/kernel (e.g., the host OS 341) and the daughter OS 331 comprise upstream operating system distributions, for example distributions based on Red Hat, Debian, or Ubuntu, and the device-driver functionality is distributed as part of the upstream operating system distribution or as part of the distribution's standard package mechanisms. In this manner, installation of the upstream operating system distribution, and subsequent routine updates of the operating system distribution using the distribution's normal update mechanisms, install and update the device-driver functionality without requiring a separate user-space program that is obtained from a separate repository and manually installed, executed, or maintained specifically for enabling host-daughter networking behavior. In some embodiments, eliminating a separate repository and separate user-space program reduces operational complexity, reduces the number of separately managed software components, and reduces the likelihood of version skew between operating system updates and host-daughter networking support.

### Details of Packet Transfer

In come embodiments, after completing or initiating a DMA, the DTH device driver 332 may cause an interrupt to be signaled to the HTD device driver 345. In response to the interrupt, the HTD device driver 345 may access a location within host memory 231 that has been indicated by the DTH device driver 332. DTH device driver 332 may have written location within host memory to one or more registers or memory locations and host driver may access this information via memory-mapped I/O (MMIO) style access over PCIe. In this manner the host driver may obtain a pointer or address identifying the DMA'd data region in host memory. The HTD device driver 345 may then read the meta-data from the DMA'd data region.

In some embodiments, when a DMA operation transferring packet data across the electrical coupling (e.g., PCIe wires 301 between the daughter server 140 and the host server 110) completes, then an interrupt service routine (ISR) in the receiving server (host server 110 or daughter server 140b) causes the packet data to be processed. For example, when the daughter server 140b is the receiving endpoint, the DTH device driver 332 may signal the networking stack in the daughter OS 331 that a new packet 355 is available on its eth0 network interface; conversely, when the host server 110 is the receiving endpoint, the HTD device driver 345 may similarly notify the host-side networking stack in the host OS/kernel (e.g., the host OS 341).

In some embodiments the flow of sending data between servers may proceed as follows. A host server 110 receives a packet 355 in the NIC device driver 344. The packet 355 is emitted from the NIC device driver 344 through its network-interface entry point into the host networking stack in the host OS/kernel (e.g., the host OS 341), which examines the packet and consults its forwarding table 343. When the destination IP address corresponds to the daughter server 140b, the host networking stack forwards the packet to the HTD device driver 345, which has registered itself as the network interface corresponding to the daughter server IP address 333. The HTD device driver 345 notifies a DTH device driver 332, which causes the packet 355 to be transferred (e.g., via DMA) from the host memory 231 to daughter memory 330. The DTH device driver 332 then presents the packet to the daughter server networking stack in the daughter OS 331, which recognizes that the destination IP address 333 matches the daughter server 140b, extracts the payload, and adds the payload to a buffer that is available to the application in daughter memory 330. The networking stack may notify the application 334 when data is available in the buffer, for example after one or more packets have been received.

In some alternative embodiments, a larger portion of the network-stack work is performed on the host server 110. For example, from the perspective of the external network (e.g., the datacenter network 201), the receive path may proceed as if the host server 110 itself were the ultimate endpoint: the NIC 120 receives packets 355, the host TCP/IP stack in the host OS/kernel (e.g., the host OS 341) reassembles packets into larger data units (e.g., data chunks), and upper-layer protocols are processed at least partially on the host. In such embodiments, the HTD device driver 345 may assemble packet payloads into a chunk in host memory 231 and then inform the DTH device driver 332 of the chunk. The chunk may then be transferred via DMA from host memory 231 to daughter memory 330 over the PCIe wires 301. On the daughter server 140b, the DTH device driver 332 may present the chunk to the daughter server stack in the daughter OS 331 in a manner that emulates one or more lower-layer protocol stages, effectively tricking one or more sub-layers of the stack so that the remaining layer(s) can interact with the application 334 as if the full protocol stack had executed locally on the daughter server 140b. In this way, the majority of the network-processing work can be shifted to the host server 110 while the daughter server 140b still sees an appropriate abstraction at the upper layers.

In some embodiments, the data and associated meta-data may be transmitted between the host server 110 and daughter server 140b either in packet form or as larger chunks with associated meta-data. In some embodiments, the data transferred between the host server 110 and daughter server 140b is in the form of TCP/IP-style packets 355. In other embodiments, the host server 110 and daughter server 140b communicate data in a format in which bulk data chunks and meta-data (e.g., addresses, sequence information, flow identifiers, or application-level message boundaries) are transferred over the PCIe wires 301.

In some embodiments, the following general pattern is used by the networking stack. A device driver, such as NIC device driver 344 or HTD device driver 345, registers itself with the networking stack as being of a particular type of network interface. IP addresses, such as IP address 342 of the host server 110 or IP address 333 of the daughter server 140b, are associated with each such network interface, and a table, such as forwarding table 343 in the host server 110, is maintained that associates each network interface with one or more reachable IP-address ranges (e.g., subnets). When a packet 355 is processed by the networking stack, the destination IP address is extracted from the packet and compared to the table of IP-address ranges to identify the best-matching entry (for example, using longest-prefix-match rules). The entry that best matches the destination IP address identifies a network interface to which the packet should be forwarded. The networking stack then provides the packet to the device driver corresponding to that interface, for example by calling a function in the device driver and passing in a data structure representing the packet.

In some embodiments, the daughter server 140b can perform a network boot as part of its power-on sequence. For example, the daughter server 140b may send out network-boot-type broadcast packets (e.g., DHCP discovery packets) that reach a DHCP server on the local area network (LAN) via the datacenter network 201. In one illustrative configuration, a boot disk for the daughter server 140b is associated with an IP address 333 (e.g., 10.0.0.1), and the daughter server network boot process causes traffic destined to that IP address (e.g., the IP address of the daughter server) to be directed to the daughter server 140b over the host-daughter link formed by the PCIe wires 301.

In one non-limiting example of a netboot sequence, the NIC 120 in the host server 110 is associated with an IP address 342 such as 10.0.0.2, and the host OS/kernel (e.g., the host OS 341) associates a host-side daughter-interface (e.g., eth19) with IP address 333 as 10.0.0.1, which is logically the IP address of the daughter server 140b or its boot service. A client on the Internet, such as device 203, sends one or more IP packets 356 to IP address 333. These packets may be routed through the Internet 207 and the datacenter network 201 and arrive at the NIC 120, where they may be received and presented to the host networking stack in the host OS/kernel (e.g., the host OS 341) via the NIC device driver 344. The TCP/IP stack examines the destination IP address, consults (e.g., queries) the forwarding table 343 in the host server 110, and determines that IP address 333 is associated with the daughter-interface eth19. The packets are forwarded to eth19, which causes the HTD device driver 345, corresponding to eth19 on the host server 110, to be activated. The HTD device driver 345 engages in a protocol with a daughter server endpoint in the daughter server 140b, and the packets 355 (or packet payloads) are transferred over the PCIe wires 301 into daughter memory 330.

In some embodiments, when the packets arrive at the daughter server 140b, an interrupt may be triggered within the daughter server by the HTD device driver 345 as part of the protocol, and the daughter server ISR may then initiate a DMA transfer of the packet data from host memory 231 to daughter memory 330. The DTH device driver 332 that interacts with the PCIe endpoint logic 324 in the SoC 320 in daughter server may be registered as eth0 within the daughter OS 331, such that when the DMA completes the ISR causes the DTH device driver 332 to notify the TCP/IP stack that an IP packet 355 has been received on eth0. From the perspective of the host server 110, this behavior is perceived as forwarding an IP packet 355 from one network interface to another (from the NIC 120 to the daughter server interface associated with the HTD device driver 345). From the perspective of the daughter OS 331, this behavior is perceived as receiving a packet from the Internet 207 on its eth0 interface. In this manner, the daughter server 140b may run a normal, upstream, unmodified Linux distribution while participating in standard netboot mechanisms and being reachable as a separate device with its own IP address 333.

In some embodiments, the daughter server 140b and host server 110 communicate in the form of IP packets such as the packet 355 over the electrical coupling (e.g., the PCIe wires 301). In other embodiments, the daughter server 140b and host server 110 communicate data in the form of data chunks plus associated meta-data, where the host server 110 divides the data to communicate into packets for transmission on the datacenter network 201 but may collect and send larger data chunks toward the daughter server 140b over the PCIe wires 301, and may likewise receive packets, extract data, collect that data into chunks, and transfer those chunks to the daughter server 140b as one or more bulk transfers.

In some embodiments, a protocol by which the DTH device driver 332 interacts with the HTD device driver 345 represents or leverages the action of the host-side network stack in the host OS/kernel (e.g., the host OS 341). For example, as packets 355 move between the NIC 120 and the daughter server interface corresponding to the HTD device driver 345, the network stack in the host OS 341 consults (e.g., queries) a forwarding table 343 that contains an entry for each network interface, including entries for each daughter server interface and for the NIC 120. Each entry identifies a range of IP addresses reachable via the corresponding interface. When a packet 355 is to be forwarded, the network stack looks in the table 343 to find an interface whose address range includes the destination IP address of the packet, and then gives the packet to the corresponding device driver. In this way, packets 355 can move from the NIC 120 (and thus from the datacenter network 201) to a daughter server interface, or vice versa, with no additional software modification or special program in either the host server 110 or the daughter server 140b.

The following shows part of the terminal output of a common ifconfig command when executed in a Linux operating system:
eth19: <BROADCAST, MULTICAST, UP, LOOPBACK, RUNNING>
Link encap:Ethernet
Hardware addr 00:0c:29:a2:b3:c4
inet addr:192.168.1.100 Bcast:192.168.1.255 Mask:255.255.255.0

This indicates that a device is present in the server that has registered itself with the host OS to be of the type network interface. A NIC device may appear in this fashion. A daughter server, when inserted into the host server, may cause ifconfig or a similar tool that reports the presence of network devices to display an entry similar to this. When a plurality of daughter servers are inserted into bays in the host server, each will appear in ifconfig or similar report as a network device. In this case, the interface is named “eth19.” Other daughter server that are also inserted into bays in the Host may similarly appear as “eth” followed by other numbers.

Consider an example of the flow of packets. In this arbitrary example a packet enters the datacenter network 201 via gateway 206. A packet 356 originates on device 203 and is addressed to daughter server 140b by using the IP address assigned to daughter server 140b (e.g., the IP address 333). Packet 356 is routed through Internet 207 according to its destination IP address and arrives at gateway 206. Internet routing is performed at the IP layer, and therefore when packet 356 arrives at gateway 206 it does not contain a destination MAC address corresponding to any specific link in the datacenter network 201.

In some embodiments, gateway 206 determines that the destination IP address of packet 355 corresponds to a device that is reachable via datacenter network 201, which in many embodiments is an Ethernet network. Gateway 206 therefore needs to determine a destination MAC address in order to transmit the packet onto the Ethernet network. Gateway 206 consults its ARP table for the destination IP address contained in packet 355. In the present example, for illustrative purposes only, the ARP table of gateway 206 does not contain an entry mapping that IP address to a MAC address.

In response, gateway 206 creates an ARP request frame and broadcasts the ARP request onto the datacenter network 201. Because the ARP request is broadcast, it is propagated to all reachable servers and switching elements in the Ethernet broadcast domain. The NIC 120 (which is associated with the host server 110 that houses or otherwise includes the daughter server 140b) receives the ARP request packet. The ARP request packet is delivered from NIC 120 into host memory and emerges from the network interface of the NIC device driver 344 that fronts NIC 120.

The networking stack in host OS 341 processes the ARP request packet and forwards it to the other network interfaces that are registered in the host networking stack, including the host-to-daughter (HTD) network interface associated with the HTD device driver 345, unless forwarding on a particular interface is disabled by an anti-loop protocol or similar mechanism. Forwarding the ARP request to the HTD interface causes the HTD device driver 345 to interact with daughter server 140b over the electrical coupling. In some embodiments, the HTD device driver 345 triggers a PCIe-conformant interrupt or message to daughter server 140b, which causes an interrupt service routine in daughter server 140b to execute. The interrupt service routine may initiate a DMA transfer that copies the ARP request packet from host memory 231 into daughter memory 330.

The daughter OS 331 includes an ARP protocol component as part of its networking stack, and that component processes the ARP broadcast packet that has been transferred into daughter memory. The ARP request contains a requested IP address 333 that matches the IP address assigned to daughter server 140b. In response to this match, the daughter networking stack constructs an ARP response packet. In some embodiments, the source MAC address from the ARP request packet is copied and used as the destination MAC address of the ARP response packet, and the ARP response packet is populated with the IP and MAC address information for daughter server 140b as the replying node.

The ARP response packet is then transferred from daughter server 140b to the host server 110 using the mechanisms described in this disclosure, for example by using a DMA transfer over the PCIe electrical coupling and a protocol between the DTH device driver 332 and the HTD device driver 345. Once the ARP response packet resides in host memory 231, the host networking stack forwards the ARP response packet to the NIC device driver 344 associated with NIC 120. At some point in this process, the source MAC address of the ARP response packet is set to the MAC address of NIC 120. NIC 120 then transmits the ARP response packet out onto the datacenter network 201.

The ARP response packet travels through datacenter network 201 to gateway 206. At each hop along the path, a switch uses the destination MAC address in the ARP response packet to determine which output connection to use when forwarding the packet. As the packet traverses the switches between NIC 120 and gateway 206, each switch may update its internal lookup table to associate the source MAC address (which is the MAC of NIC 120) with the ingress port on which the ARP response was received. When gateway 206 receives the ARP response packet, gateway 206 records the source MAC address from the packet, which is the MAC address of NIC 120, into its ARP table as the MAC address corresponding to the IP address 333 of daughter server 140b. Subsequently, when packets arrive at gateway 206 from Internet 207 with destination IP address 333, gateway 206 can place the MAC address of NIC 120 into the destination MAC address field of those packets by consulting its ARP table. Each switch in the path then uses that destination MAC address to forward the packet along the same path on which the ARP response was previously received, thereby guiding packets toward NIC 120 and ultimately toward daughter server 140b.

In another example, consider packets initiated inside daughter server 140b. An application running on daughter server 140b may make a call to a socket, by which the application provides the contents of a data buffer to the socket to be sent to a target receiving server identified by a destination IP address. The socket call causes a first layer of the networking stack in the daughter OS 331 to execute. This first layer may divide the application-supplied data into chunks, such as chunks of approximately 64 kilobytes, or other suitable size, based on configuration and protocol considerations. The first layer then provides each chunk of data to a second layer of the networking stack.

A second-layer protocol component in the daughter networking stack processes each chunk. In some embodiments, the second layer extracts smaller portions of data from the chunk, assigns each portion as the payload of an individual packet, and constructs complete packets by generating the appropriate transport-layer and network-layer headers, and any corresponding trailer information, around each payload. The resulting completed packets are then provided to the daughter-to-host device driver (e.g., the DTH device driver 332).

In some embodiments, the DTH device driver 332 initiates a DMA operation over the PCIe electrical coupling to transfer the completed packet (or packets) from daughter memory 330 into host memory 231. Upon completion of the DMA, PCIe endpoint logic on the daughter server generates an interrupt, which causes an interrupt service routine to run on the daughter server. In some embodiments, that interrupt service routine, executing on the daughter server, then issues a PCIe-conformant interrupt signal or message-signaled interrupt (MSI or MSI-X) toward the host's PCIe root complex. This host-directed interrupt causes a corresponding interrupt service routine associated with the HTD device driver 345 to execute on the host server. The host-side interrupt service routine retrieves information about the packet or packets that now reside in host memory 231 and prepares those packets for processing by the host networking stack.

In some embodiments, the HTD device driver 345 then pushes the packet out of the HTD device driver interface into the host networking stack. The host networking stack examines the destination IP address of the packet and consults (e.g., queries) a forwarding table that associates ranges of IP addresses with network interfaces that have registered themselves with the host networking stack as being of the network interface type. The host networking stack selects the best match, for example using longest-prefix-match semantics, and hands the packet to the corresponding network interface. When the destination IP address indicates that the target is reachable on the external network, the packet is handed to the NIC device driver 344 that fronts NIC 120. The NIC device driver 344 then causes NIC 120 to send the packet out over the datacenter network 201 toward the destination server.

In an alternative embodiment for sending data from daughter server 140b to the external network, the application running on the daughter server again makes a call to a socket to send data. The call causes the first layer of the daughter networking stack to execute and divide the application-supplied data into chunks. The first layer then passes each chunk to a second layer of the networking stack. In this alternative embodiment, the second-layer component hands off the entire chunk, along with associated meta-information, to a DTH device driver (such as the DTH device driver 332), rather than performing packet-by-packet segmentation on the daughter server.

In some embodiments, the call from the second-layer networking component is redirected to the daughter server's device driver (the DTH device driver 332). In such embodiments, the DTH device driver 332 initiates a DMA operation to transfer the entire chunk of data from daughter memory 330 into host memory 231, and also initiates DMA to transfer meta-data that describes the chunk, such as size, location, and protocol parameters.

Upon completion of the DMA operations, the PCIe endpoint logic on the daughter server again generates an interrupt that causes an interrupt service routine to run on the daughter server, and that interrupt service routine may in turn cause an interrupt to be delivered to the host server via PCIe. In response to the interrupt being triggered in the host, an interrupt service routine associated with the HTD device driver 345 executes on the host server and receives information about the location of the chunk and associated meta-data in host memory 231.

In some embodiments, the HTD device driver 345 then causes a second layer of the host server's networking stack to receive the chunk of data and the meta-data. The HTD device driver 345 may emulate the behavior of a first-layer segmentation component of the networking stack and may present the chunk and meta-data to the second-layer component in the same manner as would occur if the data had originated from an application executing on the host. In effect, the HTD device driver 345 impersonates the first layer of the networking stack and causes the host networking stack to treat the daughter-originated data as though it originated on the host. The HTD device driver 345 thus makes a call into the second-layer networking stack on the host and hands the chunk and meta-data to that component.

After this handoff, the second layer of the host networking stack proceeds in the same way that it would normally proceed if the data actually originated on the host. The remaining layers of the host networking stack perform the steps of converting the data of the chunk into a plurality of packets, generating and adjusting the appropriate headers and checksums, and sending the packets to the NIC device driver 344 for transmission. The NIC device driver 344 then causes NIC 120 to transmit the resulting packets over the datacenter network 201. In this manner, the packetization and transmission work is offloaded to the host, while the daughter server is still able to initiate communication using its local networking semantics.

### Physical Characteristics

Note that FIG. 2 shows the PCIe bus fabric 240 as existing inside the Host Server. This can be interpreted to include so-called JBOD enclosures, one of which acts as a physical extension of a server enclosure and thereby allows “more things to be plugged into the physical server”, in particular additional SSDs can be housed in a JBOD type of enclosure and the JBOD is connected to the Host Server and this in turn connects the SSDs in the JBOD to the PCIe bus fabric 240 of the Host Server.

A plurality of physical servers (shown as physical servers 290) are communicably coupled with datacenter network 201 by means of the top of rack switch 205 that is at the top of the rack that holds the physical servers 290. For example, the physical servers 290 may be directly coupled with the top of rack switch 205 such that the physical servers 290 may transmit one or more data packets to the top of rack switch 205. The datacenter network 201 may contain any number of TOR switches, each at the top of a rack, and connected to a higher level switch (shown as root switch 202), variously called root switch, row switch, and so on. Each data center chooses a number of switches and servers and connects them in a manner that is specific to company policies, needs of the workload, choices of available equipment and so on. The present disclosure describes a system that works with all such topologies, collections of switch types, etc., as long as packets can be communicated between the physical servers 290 (or any other devices for which the desire is to interact with Daughter servers) and Host servers that contain the target Daughter Servers.

### Clarifications and Details

Note that in the disclosure, “eth19” and similar strings of characters are used for illustrative purposes only. The “eth” is a standard string used by many operating systems to denote an ethernet style network interface, and “19” is dynamically assigned, as such the exact string is illustrative only. There is no requirement for the daughter server to appear as “eth.” The details are not material to the disclosure, but are rather provided as an aid to the disclosure. Such details include the string “eth,” particular IP addresses, the use of DHCP, TFTP, NFS, network boot, and ethernet LAN, all of which are particular details of a particular example and are not limiting.

Note: this particular description illustrates things in terms of details of the Linux kernel and a Linux OS distribution, for example, a normal, upstream, and unmodified Linux distribution. However, the same principles apply to any operating system, whether it may be for a server, such as a Windows based OS, or for a mobile device such as Android based OS. The pattern is that a device driver has two interfaces: on one side, the driver interfaces with the operating system or a separate network stack that interacts with the operating system, such as user-space networking stacks like VPP, and on the other side, the device driver interfaces with hardware . . . both the hardware of the Host server, such as the Root Complex or equivalent logic that implements the hardware communication protocol, and also the hardware that is on the other side of the electrical connection. In this case the electrical connection is PCIe protocol and electrical signaling, but it may alternatively be IDE or SCSI, or any other electrical connection specification.

In some embodiments, the CPU 230 may be in communication with PCIe Root Complex (shown as PCIe RC 346) of the host server 110. For example, the CPU 230 may provide the address (within memory of the host server 110) and size of the packet 355 as well as a target destination address to the PCIe RC 346. As another example, the CPU 230 may receive one or more messages from the PCIe RC 346. As shown in FIG. 3, the PCIe RC 346 is communicably coupled with PCIe endpoint logic 324 of the daughter server 140b via PCIe wires 301.

In some embodiments, the HTD device driver 345 may use MMIO connection to RC to communicate the address of packet 355 and size of packet 355 and a desired destination PCIe bus address to RC. Then the HTD device driver 345 may write to a particular MMIO address that is connected to the PCIe RC 346 that triggers RC to initiate and perform a Direct Memory Access transfer, in which RC reads directly from host memory 231 via the connection that is labeled DMA, and then transports that data that we read over PCIe wires, where the PCIe wires act as an electrical coupling, in the form of PCIe TLP packets. The TLP packets contain an address that is an intermediate address specific to the PCIe bus. PCIe endpoint logic 324 receives the TLP packet, translates the intermediate bus address to an address inside daughter server 140b, and uses EP connection to daughter memory 330 to store the data that was contained inside TLP packet into daughter memory 330. In this way, RC and EP together move the packet data directly from host memory 231 to daughter memory 330. Note on address-RC translates an address that is in host address space into an intermediate PCIe bus address, and the EP translates intermediate bus address into an address inside daughter server address space. Note that the daughter server may also initiate such a DMA transfer, via the end point logic that is part of the daughter server, over the electrical connection that similarly directly moves data from daughter server memory to host server memory.

In some embodiments, when the host server 110 is initially powered on or otherwise activated, the host OS 341 or BIOS 347 may use PCIe RC 346 to probe each socket to determine if a device has been inserted into the socket and so inserted into host server 110 and if so, obtain relevant configuration data for that device. In some embodiments, the BIOS 347 of the host server 110 may be the software that probes the PCIe sockets of the host server 110, reads configuration information from the device, and writes parameter values into the device, then communicates the relevant information to the host OS 341.

In some embodiments, when one or more sockets are occupied (e.g., a device is inserted into one or more of the bays 130), the CPU 230 may read PCIe configuration space of each device plugged into the sockets. The CPU 230 can obtain or otherwise identify at least one of a device type, a vendor identification (ID), a device ID, and a socket ID, for each device plugged into the host server 110.

In some embodiments, the BIOS 347 may indicate or otherwise make available the IDs of the PCIe devices to the host OS 341. For example, the BIOS 347 may make the vendor ID, device ID, and device type available to the OS of the host server 110. In some embodiments, with a Linux system, the OS kernel may be distributed together with one or more PCIe device driver modules wherein each device driver module may be associated with a vendor ID, device ID and device type. The device driver module associated with the vendor ID, device ID, and device type that was previously read from a device that is detected as inserted into a socket is typically loaded by the kernel and the initialization of that driver is performed. By this mechanism, the HTD device driver 345 associated with the vendor ID, device ID and device type the daughter server 140b, can be loaded into the host OS 341. Upon OS calling the init function of the HTD device driver 345, the HTD device driver 345 can register itself as the type network interface driver.

In some embodiments, the HTD device driver 345 registers with the host OS/kernel (e.g., the host OS 341) as an Ethernet-type network interface such that, from the perspective of the host OS 341, the HTD device driver 345 appears as a conventional Ethernet network device. In such embodiments, the host OS/kernel (e.g., the host OS 341) assigns an interface identifier to the Ethernet-type network interface exposed by the HTD device driver 345, and associates the IP address 333 with the daughter server, or a subnet including the IP address 333, with that Ethernet-type network interface in the forwarding table 343. In some embodiments, the DTH device driver 332 similarly registers with the daughter OS 331 as an Ethernet-type network interface, such that the daughter OS 331 treats packet 355 (in daughter memory 330) delivered via the DTH device driver 332 as packets received on an Ethernet network interface.

### Alternative Embodiments

In some embodiments, the host OS 341 starts an instance of a device driver for each daughter server 140b, that is present in a PCIe socket. In some other embodiments the host OS 341 starts one instance of a device driver that interacts with the servers (e.g., one or more daughter servers 140b) that are present in one or more PCIe sockets. In some embodiments, each device driver that is of the type network interface may have or include a corresponding IP address. The IP addresses associated with the network interfaces that have been registered by the HTD device driver 345 may typically match the IP address for which the OS of the daughter server 140 (e.g., the daughter OS 331) is configured. In some embodiments, the forwarding table 343 may forward, provide, or otherwise cause passing of packets 355 between the NIC 120 and the daughter server 140b.

In some embodiments, one or more packets may originate in the datacenter server 291. For example, the datacenter server 291 may transmit, via a NIC 350, a packet 355 to datacenter network 201. In some embodiments, the packet 355 may include a destination IP address (e.g., an IP address or a destination address of the device for which the packet is intended). The datacenter network 201 may forward or otherwise provide the packet 355 to the host server 110, which may ultimately reach the daughter server 140b.

In some embodiments, the packet 355 may start or otherwise originate in memory 351 of the datacenter server 291. The packet 355 may include an IP address 333 (shown as IP address of the daughter server 140b) which represents a destination IP address. In some embodiments, the packet 355 may be given or provided the MAC address of the NIC 120. The packet 355 may consist of or include one or more bits that move or otherwise travel through the datacenter network 201.

In some embodiments, the datacenter network 201 may be of the type ethernet and the datacenter network 201 may steer or otherwise direct one or more packets via MAC addresses or IP addresses or equivalent type of address in fibre channel network or equivalent type of network. The packet 355 may arrive at the top of rack switch 205. The packet 355 may arrive via copper wires, fiber optic, wireless connection, or other means of connection to carrying packets such as IP packets. Upon receipt or arrival of the packet 355, the top of rack switch 205 may utilize the MAC address to look up or otherwise determine a corresponding network port. The top of rack switch 205 may forward or otherwise provide, via the network port, the packet 355 to the root switch 202. In some embodiments, the root switch 202 may use the MAC address to identify the top of rack switch 204. Upon receipt of the packet 355 at the top of rack switch 204, the top of rack switch 204 may use the MAC address to identify the host server 110. Responsive to identification of the host server 110, the top of rack switch 204 may forward or otherwise provide the packet 355 to the NIC 120.

In some embodiments, upon receipt of the packet 355, by the NIC 120, the packet 355 may be transferred to the host memory 231 by the NIC device driver 344 (e.g., device driver for NIC 120) in combination with PCIe RC 346. In some embodiments, the bits (e.g., contents) of the packet 355 may be stored or otherwise maintained in the host memory 231. In some embodiments, the host OS 341 may extract the destination IP address from the packet 355. For example, the host OS 341 may extract the IP address 333 from the packet 355.

In some embodiments, the host OS 341 may determine that the extracted IP address does not match the IP address of the host server 110 (e.g., IP address 342). In some embodiments, the host OS 341 may forward the packet 355 to the HTD device driver 345 (e.g., device driver that was loaded for the daughter server 140b). For example, the host OS 341 may make a call to the HTD device driver 345. In some embodiments the portion of the host OS 341 that may extract IP address, look up (e.g., query) the IP address in a forwarding table or equivalent, and then pass the packet to the HTD device driver 345 via a TCP/IP networking stack that is bundled with the host OS 341, or it may be a custom networking stack, or it may be a user space application that handles networking, or it may be a 3rd party module that has been loaded into the kernel, or it may be the equivalent.

In some embodiments, the HTD device driver 345 may initiate a protocol with the DTH device driver 332 (or vice-versa) wherein the protocol is implemented by the device drivers and facilitates the exchange of meta data about packets and/or payload data as well as transfer of packet and/or payload data itself, over the electrical connection between the host and daughter servers, such as via the PCIe wires 301. The HTD device driver 345 may be referred to as a host to daughter (HTD) device driver and the DTH device driver 332 may be referred to as a daughter to host (DTH) device driver. The protocol may be specific to or correspond to one or more characteristics or specifications of the SoC 320. In some embodiments, the bits of the packet 355 can be transferred to the daughter memory 330. The DTH device driver 332 may inform the daughter OS 331 (e.g., OS of the daughter server 140b) of the presence of the bits of the packet 355 within the daughter memory 330. In this context the daughter OS 331 may be the standard TCP/IP networking stack or a 3rd party module or user level networking stack software.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method, comprising:
establishing, by a host server, communication with a daughter server, responsive to an electrical coupling of the daughter server with the host server, wherein the daughter server is disposed within a bay of the host server; and
engaging in a protocol, by the host server in combination with the daughter server, responsive to establishing the communication between the host server and the daughter server, wherein the protocol moves data between the host server and the daughter server, and wherein the data is movable on an external network in the form of IP packets.

2. The method of claim 1, further comprising:
registering, by the daughter server, with an operating system of the daughter server, responsive to executing one or more instructions, a daughter to host (DTH) device driver, wherein the DTH device driver registers itself to be of the type Network Interface with an operating system of the daughter server; and
registering, by the host server, a host to daughter (HTD) device driver with an operating system of the host server, wherein the HTD device driver registers itself with the operating system of the host server to be of the type network interface, wherein the HTD device driver is configured to interact with the DTH device driver according to a protocol between the HTD device driver and the DTH device driver in such a way that data presented to either the DTH device driver or HTD device driver is communicated between the daughter server and the host server.

3. The method of claim 1, wherein the host server includes a network interface device associated with a packet based network, wherein the host server includes a device driver that is registered, with an operating system of the host server, as being of type network interface, and wherein the device driver is associated with the network interface device.

4. The method of claim 2, wherein the electrical coupling is of type used for storage devices including at least one of Serial Attached Small Computer System Interface (SAS), Serial Advanced Technology Attachment (SATA), Small Computer System Interface (SCSI), or Integrated Drive Electronics (IDE).

5. The method of claim 1, wherein the daughter server is configured to implement peripheral component interconnect express (PCIe) bus logic that conforms to a PCIe End Point specification, and wherein the host server is configured to implement PCIe bus logic that conforms to a PCIe root complex specification.

6. The method of claim 2, wherein the DTH device driver interacts with logic that is present in the daughter server, and wherein the logic is configured to implement peripheral component interconnect express (PCIe) bus logic that conforms to a PCIe End Point specification.

7. The method of claim 2, further comprising:
receiving, by the host server, one or more packets from a computing device, wherein the one or more packets include a destination IP address, wherein the destination IP address is an IP address of the daughter server ;
extracting, by a network software stack of the host server, responsive to receiving the one or more packets, the destination IP address from the one or more packets;
querying, by the network software stack of the host server, responsive to extracting the destination IP address from the one or more packets, a table which includes ranges of IP addresses that map to drivers that have registered themselves to be of the type network interface, to find the network interface that has the longest prefix match to the destination IP address from the one or more packets, wherein the IP address matches the IP address of the daughter server; and
handing, by the host server, the one or more packets to the HTD device driver.

8. The method of claim 1, further comprising:
receiving, by the host server, via a physical network interface device, one or more packets from a computing device, the one or more packets transmitted on the external network, wherein the data exchanged between the host server and the daughter server is associated with data included in the one or more packets; and
passing, by the host server, the one or more packets to the daughter server via a host to daughter (HTD) device driver, wherein passing the one or more packets includes:
storing, by the host server, the one or more packets or payload data of the one or more packets in memory of the host server;
transmitting, by the host server, a message to inform the daughter server of the one or more packets or the payload data; and
providing, by the host server, access to the one or more packets or the payload data such that the daughter server retrieves the one or more packets or the payload data.

9. The method of claim 2, wherein the host server includes first memory configured to store one or more packets or payload data, and wherein the daughter server includes second memory configured to store the one or more packets or the payload data, further comprising:
obtaining, by the daughter server, via the electrical coupling, the one or more packets or the payload data from the first memory; and
storing, by the daughter server, responsive to obtaining the one or more packets or the payload data, the one or more packets or the payload data in the second memory.

10. The method of claim 9, wherein the one or more packets or the payload data is obtained via direct memory access (DMA) performed over the electrical coupling.

11. The method of claim 10, wherein completion of a DMA operation causes a device driver in a receiving server to notify a network stack, in an operating system of the receiving server, that an IP packet has been received, wherein the DTH device driver is the device driver in the receiving server when the daughter server is the receiving server, and wherein the HTD device driver is the device driver in the receiving server when the host server is the receiving server.

12. The method of claim 1, wherein the daughter server is housed within a standard form factor associated with a solid state drive (SSD).

13. The method of claim 2, wherein the host server and the daughter server each execute an upstream operating system distribution and wherein network communication between the host server and the daughter server is enabled by device drivers included in the upstream operating system distribution such that installation and updating of the upstream operating system distribution installs and updates the device drivers without requiring installation of a separate program in order for the data to be communicated between host server and daughter server.

14. The method of claim 2, wherein the host server and the daughter server are detectable on the external network, and wherein the daughter server is detected as a separate device on the external network with respect to the host server.

15. The method of claim 1, wherein the daughter server includes a cluster compute style central processing unit (CPU), and wherein the cluster compute style CPU is an enterprise level server CPU.

16. The method of claim 1, wherein other servers on the external network, which the Host server is connected to, see the daughter server as a standard physical server that has an IP address discoverable and reachable on the external network.

17. The method of claim 2, wherein at least one of the HTD device driver or the DTH device driver is compatible with demikernel and IO bypass of the kernel.

18. The method of claim 3, wherein forwarding of packets between the network interface device and a daughter server interface is performed by an operating system networking stack on the host server and an operating system networking stack on the daughter server, the operating system networking stack on the host server selecting the daughter server interface using longest-prefix-match routing rules, communication of data performed from device driver in host network stack to device driver in daughter network stack without tunneling.

19. The method of claim 2, wherein the DTH device driver is registered with a host networking subsystem as a network interface of type Ethernet, thereby causing the daughter server to appear to the operating system of the host server as a physical NIC.

20. The method of claim 2, wherein the HTD device driver impersonates a first-layer protocol module of a networking stack of the host server when presenting daughter-originated data to a second-layer module, thereby causing the networking stack of the host server to treat the daughter-originated data as locally originated.

21. The method of claim 2, wherein the daughter server executes an upstream Linux operating system and processes ARP requests, IP packets, and TCP segments in a manner indistinguishable from a physical server connected directly to a datacenter network, via the DTH device driver.

22. The method of claim 1, wherein completion of a DMA transfer between the daughter server and the host server of a packet data causes an interrupt at the host server causing HTD device driver to process transferred packet data.

23. A system comprising:
a host server, including:
one or more bays, wherein a device is disposed within a bay of the one or more bays;
wherein the device includes an IP address; and
wherein the device is electrically coupled to the host server via the bay;
wherein the IP address of the device is reachable from an external network.

24. The system of claim 23, wherein the device is configured to provide at least one service to devices on the external network.

25. A system, comprising:
a host server, including:
one or more bays, wherein each bay of the one or more bays is configured to receive a device that is packaged in a predefined housing;
a daughter server to at least partially dispose in a bay of the one or more bays, wherein an electrical coupling is established between the host server and the daughter server;
wherein first data is exchanged, via the electrical coupling, from memory of the host server to memory of the daughter server;
wherein second data is exchanged, via the electrical coupling, from the memory of the daughter server to the memory of the host server; and
wherein the daughter server is discoverable on an external network;
wherein the daughter server provides one or more services to a remote device that is on the external network.

26. The system of claim 25, wherein the host server includes a host server operating system that maintains a forwarding table associating IP-address ranges with a plurality of network interfaces including (i) a network interface corresponding to a network interface device and (ii) a network interface corresponding to a host to daughter (HTD) device driver, and wherein the host server operating system forwards traffic to the HTD device driver when a destination address corresponds to an IP address of the daughter server.
